(19) United States
(12) Patent Application Publication
(10) Pub. No.: US 2026/0022677 A1
(43) Pub. Date: Jan. 22, 2026

(54) Piston Assembly

(71) Applicant: DeltaHawk Engines, Inc., Racine, WI (US)

(72) Inventor: David Keith Gill, Ortonville, MI (US)

(21) Appl. No.: 19/272,409

(22) Filed: Jul. 17, 2025

Related U.S. Application Data
(60) Provisional application No. 63/672,909, filed on Jul. 18, 2024.

(51) Int. Cl. F02F 3/00; F02F 3/28

(52) U.S. Cl. CPC F02F 3/0023; F02F 3/28

(57) ABSTRACT

A piston assembly is provided with a piston skirt coupled to a piston head. The piston skirt has an outer surface that defines a cavity between a first end and a second end of the piston skirt. A support is coupled to the piston skirt and positioned within the cavity. A wrist pin is mounted on the support. The wrist pin includes a first end and a second end. In various embodiments, the wrist pin includes a mounting wall with a surface extending along a plane from the first end to the second end, and a connecting rod is coupled to the mounting wall. In other embodiments, the piston assembly includes channels and openings to provide fluid communication for oil from an inlet located on the connecting rod to an outlet on the support in order to provide cooling to the piston head.

### CROSS-REFERENCE TO RELATED PATENT APPLICATION

The present application claims the benefit of and priority to U.S. Provisional Application No. 63/672,909 filed on Jul. 18, 2024, which is incorporated herein by reference in its entirety.

### BACKGROUND OF THE INVENTION

The present invention relates generally to the field of engines. The present invention relates specifically to a piston assembly with a support structure, wrist pin, and connecting rod for use in an engine, such as a two-stroke internal combustion engine.

### SUMMARY OF THE INVENTION

One embodiment of the invention relates to a piston assembly. The piston assembly includes a piston skirt, a piston head coupled to the piston skirt, a support, and a wrist pin. The piston skirt is centered on and extends along a longitudinal axis. The piston skirt includes a first end, a second end opposite the first end with respect to the longitudinal axis, and a body extending between the first end and the second end. The body defines a cylindrical shape and has an outer surface. The outer surface defines a cavity between the first end and the second end of the piston skirt. The support coupled to a bottom surface of the piston head. The bottom surface of the piston head faces towards the second end of the piston skirt. The support os positioned within the cavity. The wrist pin is mounted on the support and positioned within the cavity. The wrist pin is centered on and extending along a wrist pin axis that is perpendicular to the longitudinal axis.

Another embodiment of the invention relates to a piston assembly including a piston head, a piston skirt coupled to the piston head, a wrist pin, and a connecting rod. The piston skirt is centered on and extends along a longitudinal axis. The wrist pin extends along a wrist pin axis perpendicular to the longitudinal axis. The wrist pin includes a first end and a second end opposite the first end with respect to the longitudinal axis. A first protrusion extends from the first end and defines a first opening. A second protrusion extends from the second end and defines a second opening. The wrist pin further includes a mounting wall with a surface extending along a plane from the first end to the second end of the wrist pin. The connecting rod is coupled to the mounting wall and a mounting end of the connecting rod is positioned between the first protrusion and second protrusion.

Another embodiment of the invention relates to a piston assembly for an internal combustion engine. The piston assembly includes a piston skirt and a piston crown. The piston skirt extends along and is centered on a longitudinal axis. The piston skirt includes a first end, a second end opposite the first end with respect to the longitudinal axis, and a plurality of openings formed in the piston skirt adjacent to the first end. The piston crown is coupled to the piston skirt at the first end of the piston skirt. The piston crown includes a top surface facing a combustion chamber of the engine and a bottom surface opposite the top surface facing away from the combustion chamber. A gallery is defined between the first end of the piston skirt and the bottom surface of the piston crown. The piston assembly further includes a wrist pin and a connecting rod. The wrist pin is mounted to the piston skirt. The connecting rod includes a first end and a second end opposite the first end. The connecting rod is coupled to the wrist pin at the first end of the connecting rod and the second end of the connecting rod is configured to couple to a crank shaft of the engine. A first channel is formed in the connecting rod and extends between the first end and second end of the connecting rod. The first channel provides fluid communication for oil between the first end of the connecting rod and the second end of the connecting rod. A second channel extends through the wrist pin between the first channel and the plurality of openings. The second channel provides fluid communication for oil between the first channel and the gallery. The piston assembly includes an inlet providing fluid communication for oil between an exterior of the piston assembly and the first channel, and an outlet for providing fluid communication for oil between the gallery and the exterior of the piston assembly. The inlet is configured to be coupled to an oil jet.

Additional features and advantages will be set forth in the detailed description which follows and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is an isometric view of a two-stroke internal combustion engine in an inverted V-block orientation, according to an exemplary embodiment;

FIG. 2 is a front cross-sectional view of a portion of the engine in FIG. 1, according to an exemplary embodiment;

FIG. 3 is a side perspective view of a piston assembly, according to an exemplary embodiment;

FIG. 4 is an exploded view of the piston assembly of FIG. 3, according to an exemplary embodiment;

FIG. 5 is a side perspective view of the piston assembly of FIG. 3 with a transparent piston skirt, according to an exemplary embodiment;

FIG. 6 is a detailed view of the wrist pin and connecting rod of the piston assembly of FIG. 3, according to an exemplary embodiment;

FIG. 7 is a side perspective view of the wrist pin of the piston assembly of FIG. 3, according to an exemplary embodiment;

FIG. 8 is a side view of the wrist pin of FIG. 7, according to an exemplary embodiment;

FIG. 9 is a front view of the wrist pin of FIG. 7, according to an exemplary embodiment;

FIG. 10 is a bottom perspective view of the support, bushing, and wrist pin of the piston assembly of FIG. 3, according to an exemplary embodiment;

FIG. 11 is a side cross-sectional view of the piston assembly of FIG. 3, according to an exemplary embodiment;

FIG. 12 is a bottom exploded view of the connecting rod, wrist pin, bushing, and support of the piston assembly of FIG. 3, according to an exemplary embodiment;

FIG. 13 is a top perspective view of the piston assembly of FIG. 3 with the piston head disconnected from the piston skirt, according to an exemplary embodiment;

FIG. 14 is a top view of the support of piston assembly of FIG. 3, according to an exemplary embodiment;

FIG. 15 is a bottom view of the support of FIG. 14, according to an exemplary embodiment; and

FIG. 16 is a cross-sectional view of the support of FIG. 14, according to an exemplary embodiment.

### DETAILED DESCRIPTION

Referring generally to the figures, various embodiments of a piston assembly for an engine are shown. In conventional internal combustion engine, a piston pin bore is formed in the piston skirt and used to mount a wrist pin to the piston skirt. The piston pin bore is positioned along the piston skirt such that it usually crosses the intake and exhaust ports on the cylinder, which can lead to gas transfer, or leakage from the intake and exhaust ports into the piston body. A closure cap is usually used to seal the piston pin bore to reduce leakage. However, Applicant has identified that closure caps, and other sealing systems for piston pin bores, may lead to less consistent thermal loading, which may reduce the performance and efficiency of the piston.

In contrast, Applicant has developed various piston assemblies that are believed to provide for various advantages over typical piston assemblies. Specifically, the piston assemblies discussed herein include a support coupled to the piston skirt. The wrist pin is then mounted on the support. In this way, the piston skirt can have an enclosed configuration such that there are no openings for the intake or exhaust gases to pass through adjacent to the wrist pin.

In addition, the piston assemblies discussed herein include a wrist pin with a mounting wall that is substantially flat. A connecting rod is directly coupled to the mounting wall. Applicant believes that this design reduces the overall mass of the piston assembly, which may reduce stress and increase acceleration during rotation of the piston assembly.

In addition, piston assemblies discussed herein are believed to provide more efficient piston cooling. In conventional internal combustion engines, a piston head is cooled through an oil jet spraying oil onto the underside of the piston head. The oil jet is typically coupled to the crankcase or cylinder such that the oil jet remains stationary with respect to the piston assembly, as the piston assembly reciprocates in the cylinder. However, when cooling is needed the most (i.e., right after combustion), the oil jet is farthest away from the piston head, which increases the variability of the oil spray and may diminish the effectiveness of the cooling.

In contrast, the piston cooling systems discussed herein include oil fed directly through the connecting rod, and wrist pin. Applicant believes that this results in more efficient cooling by providing a continuous flow of oil at a consistent pressure and volume to the piston head.

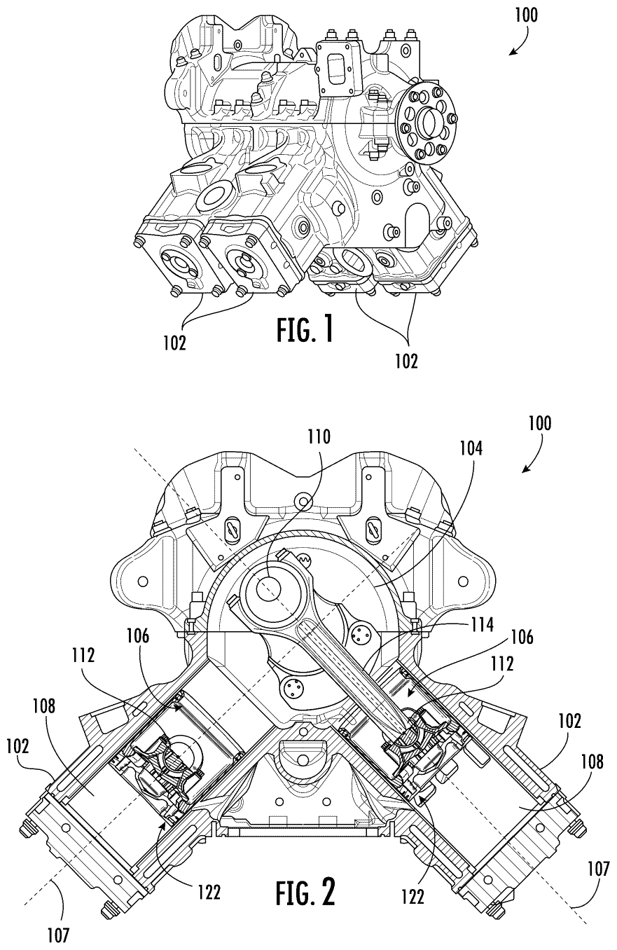

Referring to FIGS. 1 and 2, an engine 100 is shown according to an exemplary embodiment. As shown, engine 100 is an internal combustion engine and, more specifically, a two-stroke diesel engine that is oriented in an inverted V-block configuration. Engine 100 includes cylinders 102, which are positioned on a lower or bottom side of engine 10.

Referring to FIG. 2, two cylinders 102 of engine 100 are shown. Each cylinder is coupled to crankcase 104 in a generally downward direction along longitudinal axis 107. Within each cylinder 102 is a piston assembly 106. Each piston assembly 106 is positioned between a combustion chamber 108 and crankcase 104 with respect to longitudinal axis 107. When mounted in cylinders 102, piston assemblies 106 extend along and are centered on longitudinal axis 107. Piston assemblies 106 are connected to a crankshaft 110 via a wrist pin 112, or piston pin, and a connecting rod 114. Connecting rod 114 is positioned between combustion chamber 108 and crankshaft 110 with respect to longitudinal axis 107. Connecting rod 114 and wrist pin 112 allow each piston assembly 106 to travel axially within cylinder 102 as crankshaft 110 is rotated within crankcase 104. Piston assemblies 106 reciprocate within cylinders 102 of engine 100 between combustion chamber 108 and crankcase 104. Piston assemblies 106 initiate combustion of an air and fuel mixture within combustion chamber 108, which provides a force used to rotate crankshaft 110.

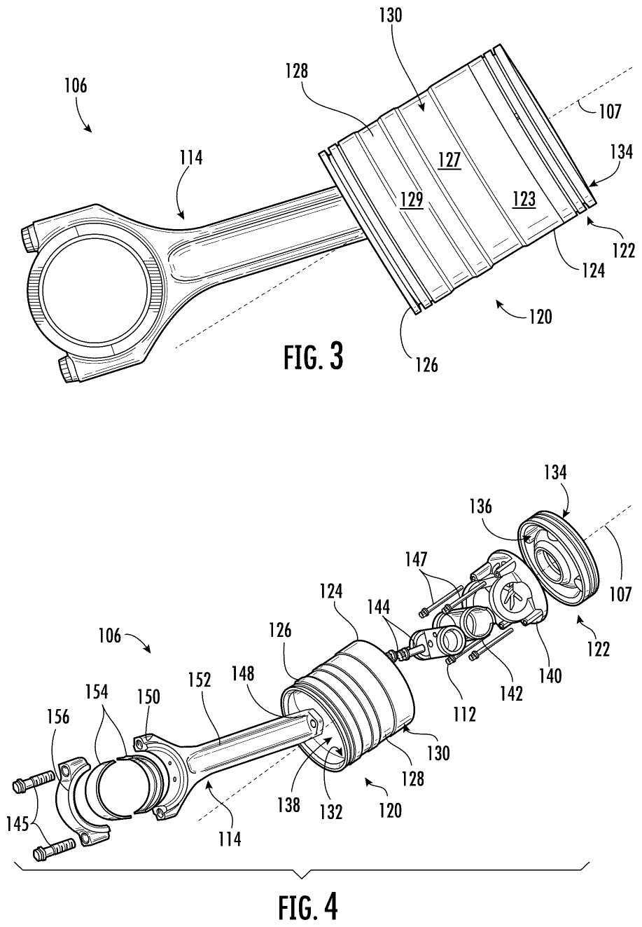

Referring to FIGS. 3 and 4, piston assembly 106 is shown. Piston assembly 106 is configured for use in an internal combustion engine, such as engine 100. Though discussed namely in the context of engine 100, the piston assemblies described herein are further applicable to other piston engines. As shown, piston assembly 106 includes a piston skirt 120 and a piston crown, or piston head 122.

Piston skirt 120 is configured to stabilize piston assembly 106 as piston assembly reciprocates through cylinder 102. Piston skirt 120 is centered on and extends along longitudinal axis 107. Piston skirt 120 includes a first end 124 and a second end 126 opposite the first end 124 with respect to longitudinal axis 107. When positioned in cylinder 102, first end 124 is located closer to combustion chamber 108 with respect to longitudinal axis 107, and second end 126 is located closer to crankcase 104 with respect to longitudinal axis 107.

Piston skirt 106 has a body 128 which extends between first end 124 and second end 126. Body 128 defines a cylindrical shape such that body circumferentially surrounds longitudinal axis 107. Body 128 may be formed from a plurality of bands, such as thrust band 123, and relief bands 127, 129. Thrust band 123 is coupled to piston head 122 adjacent to first end 124. Thrust band 123 is configured to stabilize piston assembly 106 within cylinder 102 and assists piston skirt 120 in being centered on longitudinal axis 107. Relief bands 127, 129 are coupled to thrust band 123. Relief bands 127, 129 reduce friction as piston assembly 106 reciprocates within cylinder 102. In certain embodiments, body 128 does not include relief bands 127, 129. In other certain embodiments, body 128 of piston skirt 120 is made of a single, continuous, contiguous, piece of material.

Body 128 has an outer surface 130 that faces away from longitudinal axis 107 and defines a cavity 138 between first end 124 and second end 126. Piston skirt 106 includes an inner surface 132 opposite outer surface 130. Inner surface 132 faces towards longitudinal axis 107. Outer surface 130 is spaced radially further away from the longitudinal axis 107 than inner surface 132. Cavity 138 is circumferentially surrounded by inner surface 132 such that inner surface 132 and outer surface 130 both define cavity 138. In certain embodiments, piston skirt 120 has a wall thickness of at least 1/16 inches. In other certain embodiments, the wall thickness is at most 3/32 inches. In other certain embodiments, the wall thickness is 1/16 inches to 3/32 inches. This thickness is believed to reduce the overall weight of piston assembly 106, while maintaining stability.

Piston head 122 is coupled to piston skirt 120 adjacent to first end 124. Piston head 122 is centered on and extends along longitudinal axis 107. Piston head 122 moves within combustion chamber 108 and is configured to transmit compression forces generated during combustion through piston assembly 106 to crankshaft 110 of engine 100. Piston head 122 includes a first surface, or top surface 134, that faces combustion chamber 108, and second surface, or bottom surface 136, opposite top surface 134 and facing away from combustion chamber 108 towards piston skirt 120. At least a portion of bottom surface 136 abuts body 128 of piston skirt 120 at first end 124. Bottom surface 136 faces towards first end 124 of piston skirt 120 and towards second end 126 of piston skirt 120.

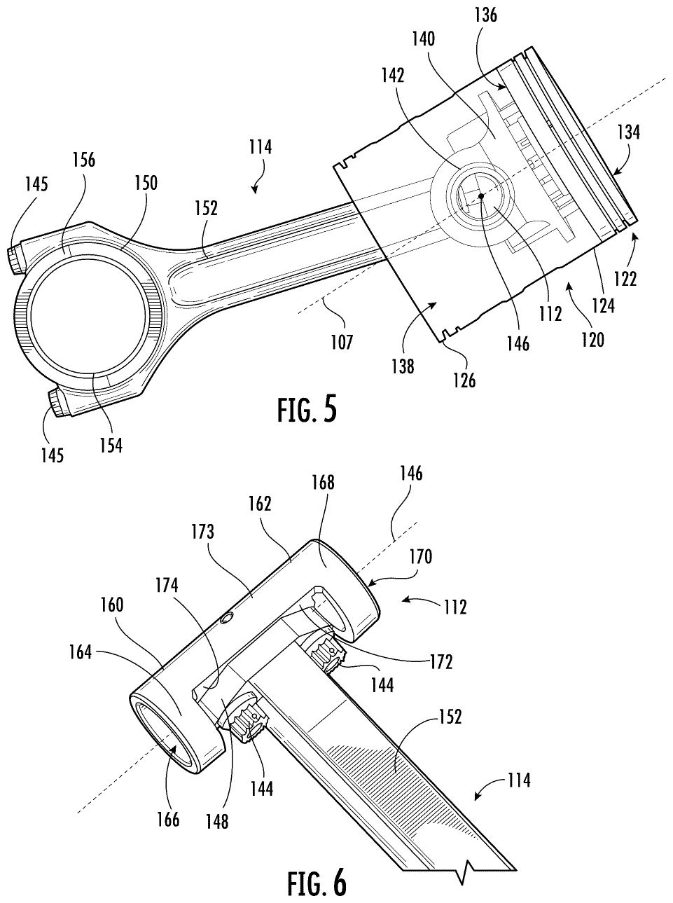

As shown in FIGS. 4 and 5, piston assembly 106 further includes a support 140, a bushing 142, wrist pin 112, connecting rod 114, and a plurality of fasteners, shown as bolts 144, bolts 145, and bolts 147. Wrist pin 112 is centered on and extends along a wrist pin axis 146. Wrist pin axis 146 is perpendicular to longitudinal axis 107. Wrist pin 112 is mounted on piston skirt 120 between first end 124 and second end 126. Wrist pin 112 is retained within body 128 of piston skirt 120. More specifically, wrist pin 112 is positioned in cavity 138 and circumferentially surrounded by outer surface 130 and inner surface 132. As shown, outer surface 130 of body 128 is continuous, without interruption, between first end 124 and second end 126 in a direction parallel to longitudinal axis 107. In this way, body 128 has no openings along outer surface 130 adjacent to wrist pin 112.

Wrist pin 112 is mounted on piston skirt 120 through support 140. Specifically, wrist pin 112 is mounted on support 140 and support 140 is coupled to piston skirt 120. Support 140 is coupled to piston skirt 120 adjacent to first end 124 and is coupled to piston head 122 adjacent to bottom surface 136. Specifically, fasteners, such as bolts 147, may be used to couple support 140 and piston head 122 together. As shown, bolts 147 extend through support 140 and through bottom surface 136 of piston head 122. In certain embodiments, support 140 is formed from a single, continuous, contiguous piece of material as piston skirt 120.

Wrist pin 112 is configured to rotate with respect to wrist pin axis 146 while mounted on support 140. Bushing 142 is positioned between support 140 and wrist pin 112 to assist with rotation of wrist pin 112 with respect to support 140.

Connecting rod 114 is coupled to wrist pin 112. Connecting rod 114 includes a first end 148, or mounting end, and a second end 150 opposite first end 148 of connecting rod 114. First end 148 is configured to couple to wrist pin 112, while second end 150 is configured to couple to crankshaft 110. Connecting rod 114 includes a shaft 152 extending between first end 148 and second end 150. Connecting rod 114 further includes bearing inserts 154 and a rod cap 156. Bearing inserts 154 are configured to surround crankshaft 110. Bearing inserts 154 are positioned between second end 150 and rod cap 156 and assist with coupling connecting rod 114 to crankshaft 110. Fasteners, such as bolts 145, can be used to secure rod cap 156 to second end 150.

Referring to FIGS. 6-9, wrist pin 112 includes a first end 160 and a second end 162 opposite the first end 160 with respect to wrist pin axis 146. A first protrusion 164 is positioned adjacent to the first end 160 of the wrist pin 112. More specifically, first protrusion 164 extends in a direction along wrist pin axis 146 away from first end 160 and away from the second end 162. First protrusion 164 defines a first wrist pin opening 166. Frist wrist pin opening 166 is centered on wrist pin axis 146. A second protrusion 168 is positioned adjacent to the second end 162 of the wrist pin 112. More specifically, second protrusion 168 extends in a direction along wrist pin axis 146 away from second end 162 and away from first end 160. Second protrusion 168 defines a second wrist pin opening 170. Second wrist pin opening 170 is centered on wrist pin axis 146. As shown, protrusions 164, 168 are circular shaped.

Wrist pin 112 includes a mounting wall 172 and a curved wall 173. Mounting wall 172 extends between first end 160 and second end 162 and, more specifically, between first protrusion 164 and second protrusion 168. Mounting wall 172 includes a surface 174 that faces towards second end 126 of piston skirt 120. As shown, surface 174 is flat. That is, surface 174 extends along a plane from first end 160 to second end 162. As shown, wrist pin axis 146 along the same plane as surface 174 and the plane bisects each of the first wrist pin opening 166 and second wrist pin opening 170. In a certain embodiment, the plane is parallel to wrist pin axis 146.

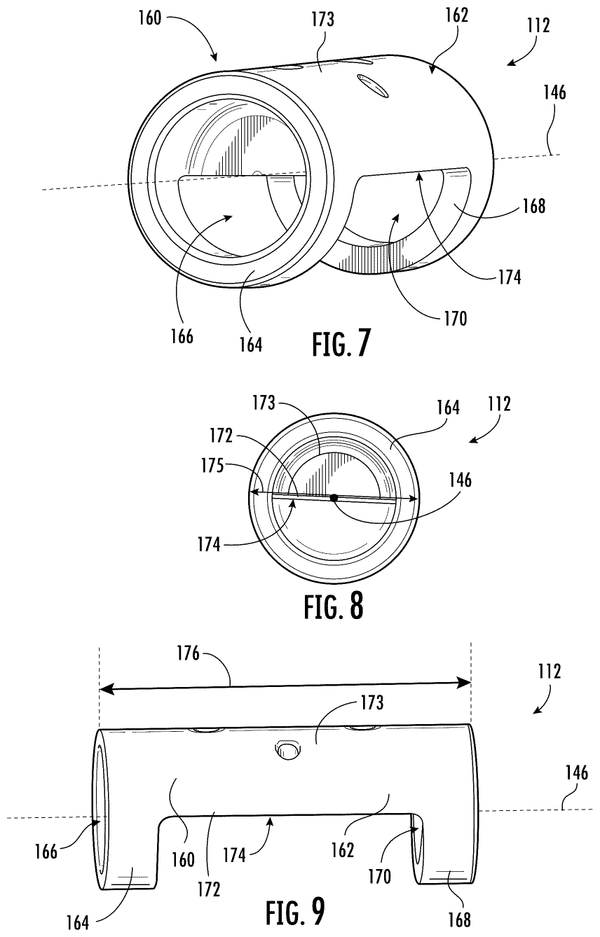

Curved wall 173 is opposite mounting wall 172 and extends in a direction away from mounting wall 172. Curved wall 173 extends between first end 160 and second end 162. Curved wall 173 has a radius of curvature. As shown in FIGS. 7 and 8, together mounting wall 172 and curved wall 173 define a semi-circular shape and protrusions 164, 168 include a first portion that is coupled to both mounting wall 172 and curved wall 173. A second portion is not coupled to the mounting wall 172 or curved wall 173 and extends away from the first portion and away from mounting wall 172 towards second end 150 of connecting rod 114.

Connecting rod 114 is coupled to mounting wall 172 of wrist pin 112. Specifically, first end 148 of connecting rod 114 is positioned between first protrusion 164 and second protrusion 168. As shown, first end 148 of connecting rod abuts mounting wall 172. Connecting rod 114 is coupled to wrist pin 112 via a plurality of bolts 144 that extend through first end 148 of connecting rod and mounting wall 172 of wrist pin 112. In particular, two bolts 144 are used to couple connecting rod 114 and wrist pin 112 together. In certain embodiments, connecting rod 114 and wrist pin 112 may be formed from a single, continuous, contiguous piece of material.

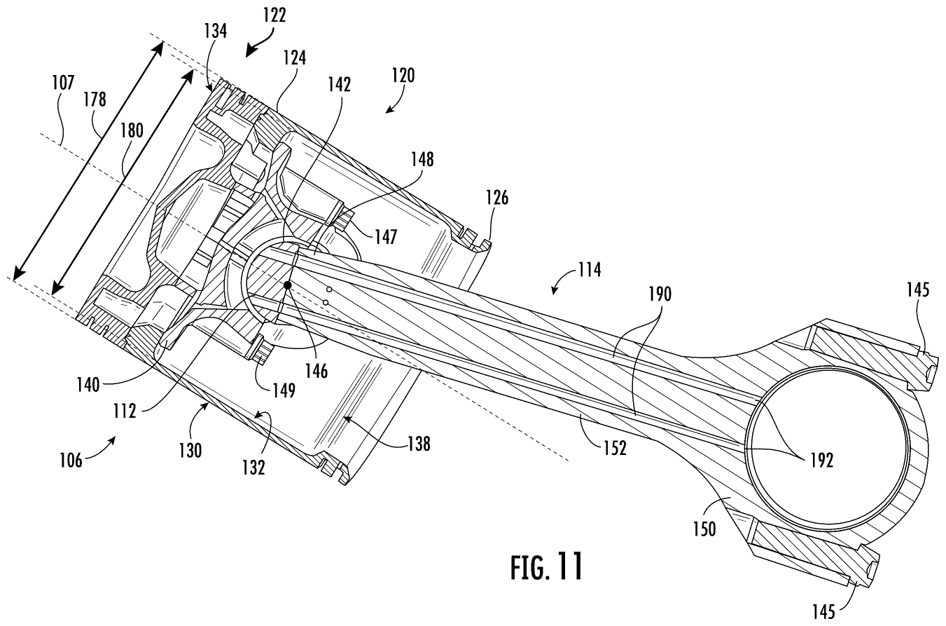

Referring to FIGS. 8 and 11, wrist pin 112 has a diameter 175 measured perpendicular to wrist pin axis 146. In certain embodiments, diameter 175 is between 25% and 35% of the length of a first diameter 178 of outer surface 130 of piston skirt 120. First diameter 178 is measured perpendicular to longitudinal axis 107. In other certain embodiments, diameter 175 is at least 25% of the length of a second diameter 180 of inner surface 132 of piston skirt 120. Second diameter 180 is measured perpendicular to longitudinal axis 107. In other certain embodiments, diameter 175 is at most 35% of the length of second diameter 180. In other certain embodiments, diameter 175 is 25% to 35% of the length of second diameter 180.

Referring to FIGS. 9 and 11, wrist pin 112 has a length 176 measured along the wrist pin axis 146. In certain embodiments, length 176 is less than first diameter 178 of outer surface 130 of piston skirt 120. In other certain embodiments, length 176 is less than second diameter 180 of inner surface 132 of piston skirt 120. In a certain embodiment, length 176 is between 65% and 80% of the length of first diameter 178 of outer surface 130 of piston skirt 120. In other certain embodiments, length 176 is at least 65% of the length of second diameter 180 of inner surface 132 of piston skirt 120. In other certain embodiments, length 176 is at most 80% of the length of second diameter 180. And, in other certain embodiments, length 176 is 65% to 80% of the length of second diameter 180.

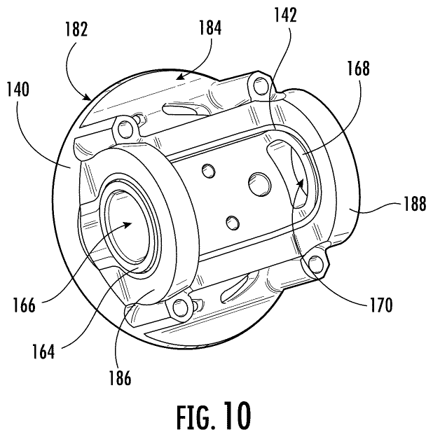

Referring to FIG. 10, a detailed view of wrist pin 112 and bushing 142 mounted on support 140 is shown. Support 140 includes a first surface 182 facing towards bottom surface 136 of piston head 122, and a second surface 184 opposite first surface 182. Second surface 184 faces away from bottom surface 136 and towards second end 126 of piston skirt 120.

A first projection 186 extends away from second surface 184. First projection 186 extends in a direction away from first end 124 of piston skirt 120 and away from piston head 122. First projection 186 defines a first support opening 187. A second projection 188 extends away from second surface 184. Second projection 188 extends in a direction away from first end 124 of piston skirt 120 and away from piston head 122. Second projection 188 is spaced a distance from first projection 186 and is substantially parallel to first projection 186. Second projection 188 defines a second support opening 189.

Wrist pin 112 is mounted on support 140 between first projection 186 and second projection 188. Wrist pin 112 is retained on support 140 by first projection 186 and second projection 188 and is retained within first support opening 187 and second support opening 189. Specifically, first support opening 187 is configured to receive and retain first protrusion 164. As shown, first protrusion 164 extends through first support opening 187. And, second support opening 189 is configured to receive and retain second protrusion 168. As shown, second protrusion 168 extends through second support opening 189. When mounted, first wrist pin opening 166 and first support opening 187 are concentric with each other, and second wrist pin opening 170 and second support opening 189 are concentric with each other.

Referring generally to FIGS. 11-16, piston assembly 106 includes a piston cooling system for cooling piston head 122 by having oil travel through connecting rod 114, wrist pin 112, and support 140 to bottom surface 136 of piston head 122.

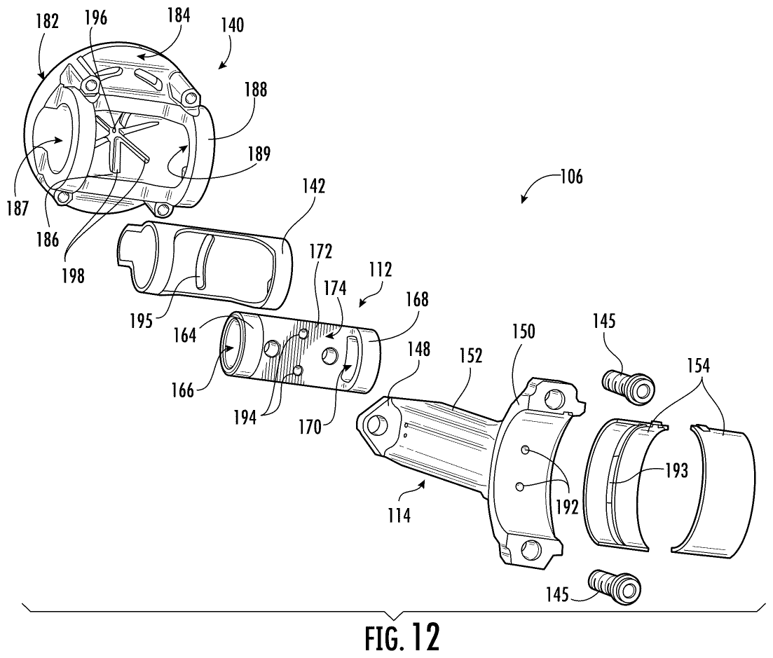

Referring to FIGS. 11 and 12, piston assembly 106 includes at least one first channel 190 formed in shaft 152 of connecting rod 114. As shown, piston assembly 106 includes two first channels 190. First channels 190 extends between first end 148 and second end 150 of connecting rod 114. Specially, first channels 190 extend parallel to each other along shaft 152. Each first channel 190 has an inlet 192 positioned near second end 150 of connecting rod 114. Each inlet 192 provides fluid communication for oil between an exterior of the piston assembly 106 and first channel 190. A slot 193 is formed in bearing insert 154 to allow oil to enter inlet 192 without interference from bearing insert 154. Slot 193 is positioned to surround inlets 192. As shown, slot 193 surrounds two inlets 192.

An oil jet may be positioned adjacent to inlets 192 to spray oil into inlet 192. In a certain embodiment, an oil jet is coupled to inlet 192. In other certain embodiments, an oil jet is coupled to crankcase 104 and is angled to spray oil into inlet 192. In other certain embodiments, crankshaft 110 includes a pressurized oil feed and is aligned with inlets 192 such that oil enters inlet 192 from crankshaft 110.

Piston assembly 106 includes at least one second channel 194. As shown, piston assembly 106 includes two second channels 194 that extend through wrist pin 112. Second channels 194 extend through mounting wall 172 and through curved wall 173 of wrist pin 112. Each second channel 194 is aligned with a corresponding first channel 190. In this way, second channels 194 provide fluid communication for oil between first channels 190 and support 140. Along wrist pin 112, second channels 194 are positioned between first end 160 and second end 162 of wrist pin 112 and, more specifically, between bolts 144. As shown, there are two second channels 194. First channels 190 and second channels 194 are oriented such that channels 190, 194 are orthogonal to surface 174 of mounting wall 172. Bushing 142 includes a slot 195. Slot 195 is formed in bushing 142 to allow oil exit second channels 194 without interference from bushing 142.

Piston assembly 106 further includes a plurality of openings 196 extending through piston skirt 120 adjacent to first end 124. More specifically, plurality of openings are formed in support 140 and extend through support 140 from first surface 182 to second surface 184. Support 140 includes a plurality of passageways 198 formed along second surface 184. Plurality of openings 196 are positioned along the plurality of passageways 198. Second channels 194 provide fluid communication for oil from first channels 190 to plurality of openings 196. More specifically, second channels 194 provide fluid communication for oil from first channels 190 to passageways 198 and passageways 198 provide fluid communication for oil from second channels 194 to plurality of openings 196. As shown, plurality of openings 196 are circular shaped.

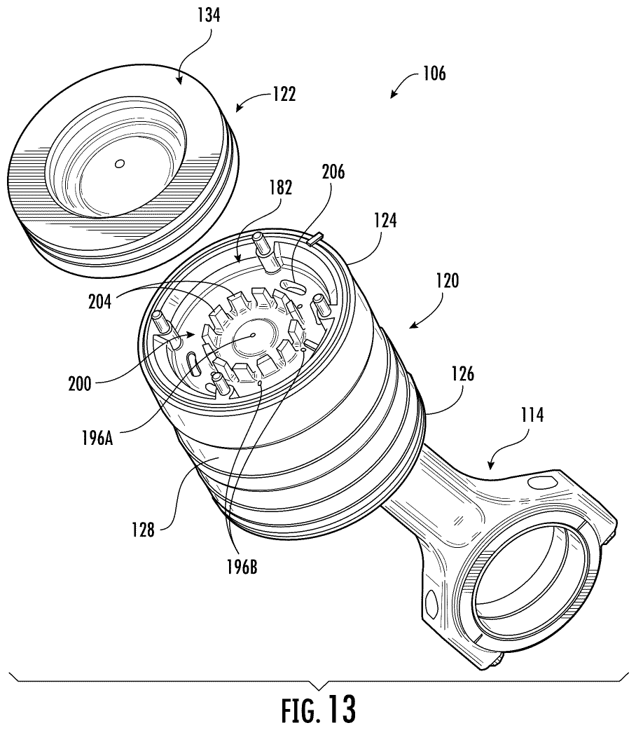

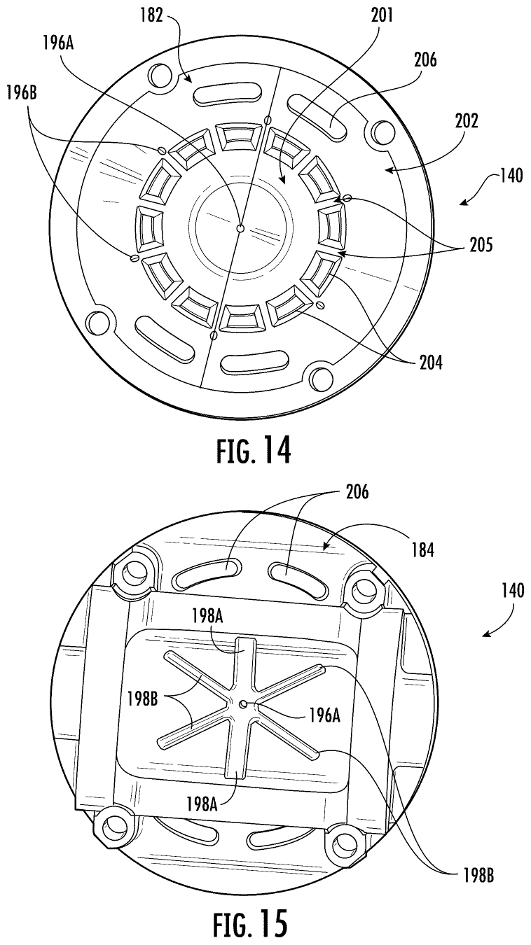

Referring to FIGS. 13 and 14, piston assembly 106 includes a gallery 200 defined between first end 124 of piston skirt 120 and bottom surface 136 of piston head 122. More specifically, gallery 200 is defined between bottom surface 136 of piston head 122 and first surface 182 of support 140. Second channels 194 provide fluid communication from first channels 190 to gallery 200. Gallery 200 is centered on longitudinal axis 107. Gallery 200 includes an inner gallery 201 and an outer gallery 202. Outer gallery 202 is spaced radially further from longitudinal axis 107 than inner gallery 201.

Support 140 includes a plurality of projections 204. Plurality of projections 204 extends away from first surface 182 of support 140 towards bottom surface 136 of piston head 122. Projections 204 are positioned circumferentially around longitudinal axis 107. Plurality of projections 204 are positioned between inner gallery 201 and outer gallery 202. Inner gallery 201 is radially closer to longitudinal axis 107 than plurality of projection 204 and outer gallery 202. Outer gallery 202 is radially further from longitudinal axis 107 than inner gallery 201 and plurality of projections 204. Plurality of projections 204 defines plurality of channels 205 which connect inner gallery 201 to outer gallery 202 and allow for fluid communication between outer gallery 202 and inner gallery 201.

Plurality of openings 196 include a first opening 196A positioned on the longitudinal axis and a plurality of second openings 196B positioned circumferentially around first opening 196A and spaced radially away from first opening 196A. As shown, first opening 196A is positioned in the inner gallery 201 and second openings 196B are positioned in outer gallery 202. Second openings 196B are adjacent to channels 205 and are configured to direct oil into channels 205. Each second opening 196B is spaced equidistant from first opening 196A. Further, each second opening 196B is spaced equidistant from the adjacent second openings 196B.

Piston assembly 106 includes at least one outlet 206 providing fluid communication between gallery 200 and the exterior of piston assembly 106. Specifically, outlet 206 extends through support 140. As shown, piston assembly includes four outlets 206. Outlets 206 are positioned in outer gallery 202. Outlets 206 are spaced a distance further from the longitudinal axis than the second openings 196B. Outlets 206 have a greater cross-sectional area than each of the plurality of openings 196.

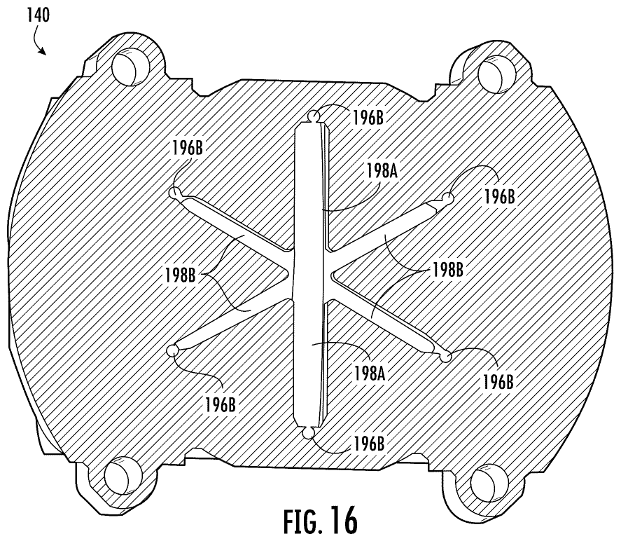

Referring to FIGS. 15 and 16, plurality of passageways 198 are shown. Plurality of passageways 198 are formed along second surface 184 of support 140 and face away from bottom surface 136 of piston head 122. Passageways 198 extend away from longitudinal axis 107 towards inner surface 132 of piston skirt 120. Each passageway 198 extends between first opening 196A and a respective second opening 196B. Specifically, each passageway 198 terminates at a second opening 196B.

As shown, support 140 includes six passageways. Passageways 198 are symmetrical across wrist pin axis 146. Two passageways 198A are oriented such that second channels 194 feed into passageways 198A. Passageways 198A align and overlap with slot 195 of bushing 142. Four passageways 198B are positioned between passageways 198A. Passageways 198A have a greater width than passageways 198B. That is, passageways 198B are narrower than passageways 198A.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes, and omissions may also be made in the design, operating conditions, and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths, and radii, as shown in the Figures are to scale. Actual measurements of the Figures will disclose relative dimensions, angles, and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A piston assembly, comprising:
a piston skirt centered on and extending along a longitudinal axis, the piston skirt comprising:
a first end;
a second end opposite the first end with respect to the longitudinal axis;
a body extending between the first end and the second end, the body defining a cylindrical shape and comprising an outer surface, the outer surface defining a cavity extending between the first end and the second end of the piston skirt;
a piston head coupled to first end of the piston skirt;
a support coupled to a bottom surface of the piston head, the bottom surface facing towards the second end of the piston skirt, the support positioned within the cavity; and
a wrist pin mounted on the support and positioned within the cavity, the wrist pin centered on and extending along a wrist pin axis, wherein the wrist pin axis is perpendicular to the longitudinal axis.

2. The piston assembly of claim 1, wherein the outer surface is continuous and without interruption between the first end and the second end in a direction parallel to the longitudinal axis.

3. The piston assembly of claim 1, wherein the body further comprises an inner surface opposite the outer surface, the inner surface positioned radially closer to the longitudinal axis than the outer surface, wherein the outer surface defines a first diameter measured perpendicular to the longitudinal axis, and the inner surface defines a second diameter measured perpendicular to the longitudinal axis, and wherein the wrist pin has a length measured along the wrist pin axis that is less than the first diameter.

4. The piston assembly of claim 3, wherein the length of the wrist pin is less than the second diameter.

5. The piston assembly of claim 4, wherein the length of the wrist pin is 65% to 85% of the second diameter.

6. The piston assembly of claim 1, wherein the support comprises:
a first projection extending in a direction away from the first end and away from the bottom surface of the piston head, the first projection defining a first opening; and
a second projection extending parallel to the first projection, the second projection defining a second opening; and
wherein the wrist pin is retained in the first opening and the second opening.

7. A piston assembly, comprising:
a piston head;
a piston skirt coupled to the piston head, the piston skirt centered on and extending along a longitudinal axis;
a wrist pin extending along a wrist pin axis perpendicular to the longitudinal axis, wherein the wrist pin comprises:
a first end;
a second end opposite the first end with respect to the wrist pin axis;
a first protrusion extending from the first end and defining a first opening;
a second protrusion extending from the second end and defining a second opening; and
a mounting wall comprising a surface extending along a plane from the first end to the second end; and
a connecting rod coupled to the mounting wall of the wrist pin such that a mounting end of the connecting rod is positioned between the first protrusion and second protrusion.

8. The piston assembly of claim 7, wherein the surface of the mounting wall is flat.

9. The piston assembly of claim 7, wherein the connecting rod and the wrist pin are formed from a single, continuous, contiguous, piece of material.

10. The piston assembly of claim 7, wherein the connecting rod is coupled to the wrist pin via at least one fastener that extends through the mounting end of the connecting rod.

11. The piston assembly of claim 7, wherein the first opening and the second opening are centered on the wrist pin axis, and wherein the plane that the surface extends along bisects each of the first opening and the second opening.

12. The piston assembly of claim 7, wherein the piston skirt further comprises a body comprising an outer surface defining a cavity, and the piston skirt further comprising a support positioned within the cavity, and wherein the wrist pin is mounted on the support.

13. The piston assembly of claim 12, wherein the support comprises a first projection configured to receive and retain the first protrusion and a second projection configured to receive and retain the second protrusion.

14. The piston assembly of claim 12, wherein the body defines a cylindrical shape, wherein the body further comprises an inner surface facing towards the longitudinal axis, and wherein the inner surface circumferentially surrounds the wrist pin.

15. A piston assembly for internal combustion engine, the piston assembly comprising:
a piston skirt extending along and centered on a longitudinal axis, the piston skirt comprising:
a first end;
a second end opposite the first end with respect to the longitudinal axis; and
a plurality of openings formed in the piston skirt adjacent to the first end;
a piston crown coupled to the piston skirt at the first end of the piston skirt, the piston crown comprising:
a top surface facing a combustion chamber; and
a bottom surface opposite the top surface facing away from the combustion chamber;
a gallery defined between the first end of the piston skirt and the bottom surface of the piston crown;
a wrist pin mounted to the piston skirt;
a connecting rod, comprising:
a first end, the connecting rod coupled to the wrist pin at the first end; and
a second end opposite the first end of the connecting rod and configured to couple to a crank shaft;
a first channel formed in the connecting rod and extending between the first end of the connecting rod and the second end of the connecting rod, the first channel providing fluid communication for oil between the first end of the connecting rod and the second end of the connecting rod;
an inlet providing fluid communication for oil between an exterior of the piston assembly and the first channel, the inlet configured to couple to an oil jet;
a second channel extending through the wrist pin between the plurality of openings and the first channel, the second channel providing fluid communication for oil between the first channel and the gallery; and
an outlet providing fluid communication for oil between the gallery and the exterior of the piston assembly.

16. The piston assembly of claim 15, wherein the piston skirt further comprises a support coupled to the piston skirt adjacent to the first end of the piston skirt, wherein the wrist pin is mounted on the support, and wherein each of the plurality of openings is formed in the support.

17. The piston assembly of claim 16, wherein the plurality of openings comprise a first opening centered on the longitudinal axis and a plurality of second openings, wherein the plurality of second openings are circumferentially positioned around the longitudinal axis.

18. The piston assembly of claim 17, wherein each of the plurality of second openings is spaced equidistant from the first opening.

19. The piston assembly of claim 17, wherein the support comprises a plurality of passageways formed along a surface of the support facing away from the bottom surface of the piston crown, wherein the plurality of passageways extends in a direction away from the longitudinal axis towards an inner surface of the piston skirt, and wherein each of the plurality of passageways terminates at one of the plurality of second openings.

20. The piston assembly of claim 16, wherein the support comprises a plurality of projections extending in a direction towards the bottom surface of the piston crown, and wherein the gallery comprises an inner gallery and an outer gallery, wherein the outer gallery is spaced radially further from the longitudinal axis than the inner gallery and the plurality of projections.
